(19) United States
(12) Patent Application Publication
(10) Pub. No.: US 2026/0210628 A1
(43) Pub. Date: Jul. 23, 2026

(54) CEMENTITIOUS BOARD DRYING SYSTEM AND METHOD FOR MAKING CEMENTITIOUS BOARD WITH DRYER

(71) Applicant: UNITED STATES GYPSUM COMPANY, Chicago, IL (US)

(72) Inventors: Te Hua LAU, Glenview, IL (US); Martin HALBACH, Niederwerrn (DE); Jacek OSINSKI, Opole (PL)

(73) Assignee: UNITED STATES GYPSUM COMPANY, Chicago, IL (US)

(21) Appl. No.: 19/410,089

(22) Filed: Dec. 5, 2025

Related U.S. Application Data
(60) Provisional application No. 63/747,656, filed on Jan. 21, 2025.

(51) Int. Cl. F26B 21/20; B28B 11/24; F26B 3/04; F26B 15/12

(52) U.S. Cl. CPC F26B 21/20; B28B 11/245; F26B 3/04; F26B 15/12

(57) ABSTRACT

A dryer is part of a system for manufacturing cementitious board. The dryer is configured to return thermal energy from waste heat exhausted from a heating section of the dryer to an entry section of the dryer upstream of the heating section of the dryer.

### CROSS-REFERENCE TO RELATED APPLICATION

This patent application claims the benefit of priority to U.S. Provisional Patent Application No. 63/747,656, filed January 21, 2025, and entitled, “Cementitious Board Drying System and Method for Making Cementitious Board with Dryer,” which is incorporated in its entirety herein by this reference.

### BACKGROUND

The present disclosure relates to a drying system for continuous cementitious board manufacturing processes and, more particularly, to a system and method for making cementitious board by drying cementitious board using at least one low-temperature zone on a board line.

In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Patent No. 5,320,677, for example. Also, many specialty materials, such as materials useful for modeling and mold-making, produce products that contain major amounts of set gypsum. Typically, such gypsum-containing cementitious products are made by preparing a mixture of calcined gypsum (calcium sulfate alpha or beta hemihydrate and/or calcium sulfate anhydrite), water, and other components, as appropriate to form cementitious slurry. In the manufacture of cementitious articles, the cementitious slurry and desired additives are often blended in a continuous mixer, as described in U.S. Patent No. 3,359,146, for example.

In a typical cementitious board manufacturing process such as wallboard, gypsum board is produced by uniformly dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material supported by a forming table.

The foamed slurry is allowed to spread over the advancing web. A second web of cover sheet material is applied to cover the foamed slurry and form a sandwich structure of a continuous wallboard preform, which is subjected to forming, such as at a conventional forming station, to obtain a desired thickness.

With the core of the board being made from increasingly less dense gypsum slurry, it can be desirable to position a more dense and/or stronger slurry against one or more of the cover sheet faces (commonly referred to as a “skim coat”) and/or at the lateral edges of the board. The skim coat can help enhance the bond between the cover sheet material and the dried cementitious material. The edge material can help allow for the handling of the board without excessive damage to its edges and also to allow for the secure attachment of the board to a framing structure via fasteners located at the edges of the board.

The calcined gypsum reacts with the water in the wallboard preform and sets as a conveyor moves the wallboard preform down a manufacturing line. The wallboard preform is cut into segments at a point along the line where the preform has set sufficiently. The segments are flipped over, dried in a dryer to drive off excess water, and processed to provide the final wallboard product of desired dimensions. The aqueous foam produces air voids in the set gypsum, thereby reducing the density of the finished product relative to a product made using a similar slurry but without foam.

Prior devices and methods for addressing some of the operational problems associated with the production of gypsum wallboard are disclosed in commonly-assigned U.S. Patent Nos. 5,683,635; 5,643,510; 6,494,609; 6,874,930; 7,007,914; and 7,296,919, which are incorporated by reference. There is a continued need in the art to provide additional solutions to enhance the production of cementitious boards. For example, there is a continued need for techniques for removing excess water from the cementitious boards using energy-efficient techniques.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing a cementitious board. In embodiments, a system for manufacturing a cementitious board includes a dryer configured to return thermal energy from waste heat exhausted from a heating section of the dryer to an entry section of the dryer upstream of the heating section of the dryer.

In one embodiment, a system for manufacturing a cementitious board includes a conveyor and a dryer. The conveyor is configured to convey the cementitious board along a machine direction. The dryer includes a housing, a heating unit, an exhaust stack, and a heat exchanger. The housing defines a board inlet, a drying chamber, and a board outlet. The board inlet and the board outlet are in communication with the drying chamber. The board inlet is arranged with the conveyor and is configured to receive the cementitious board therethrough. The drying chamber includes an entry section and a main heating section. The main heating section is disposed downstream of the entry section along the machine direction. The heating unit is configured to generate heated air and to move the heated air through the main heating section of the housing to promote convective heat transfer to the cementitious board. The exhaust stack is in communication with the main heating section of the drying chamber for expelling air from the main heating section out through the exhaust stack. The heat exchanger is operably arranged with the exhaust stack and the entry section of the drying chamber and is configured to transfer thermal energy from the exhaust stack to the entry section.

In another aspect of the present disclosure, embodiments of a dryer for a system for manufacturing cementitious board are described. In embodiments, a dryer is configured to return thermal energy from waste heat exhausted from a heating section of the dryer to an entry section of the dryer upstream of the heating section of the dryer.

In another aspect of the present disclosure, embodiments of a method of making a cementitious board are described. In one embodiment of a method of making a cementitious board, the cementitious board is conveyed along a machine direction into a board inlet of a dryer. The dryer includes a housing defining the board inlet, a drying chamber, and a board outlet. The board inlet and the board outlet are in communication with the drying chamber and are configured to permit the cementitious board to pass therethrough for conveying the cementitious board through the drying chamber. The drying chamber includes an entry section and a main heating section. The main heating section is disposed downstream of the entry section along the machine direction. Heated air is moved over the cementitious board in the main heating section. Air is exhausted from the main heating section via an exhaust stack. Thermal energy is directed from the exhausted air to the entry section.

Further and alternative aspects and features of the disclosed principles will be appreciated from the following detailed description and the accompanying drawings. As will be appreciated, the dryers, systems for manufacturing a cementitious board, and techniques for making a cementitious board disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic elevational diagram of an embodiment of a dryer constructed in accordance with principles of the present disclosure for use in a system for manufacturing a cementitious board following principles of the present disclosure.

FIG. 2 is a schematic plan diagram of an embodiment of a system for manufacturing a cementitious board constructed in accordance with principles of the present disclosure, including an embodiment of a dryer constructed in accordance with principles of the present disclosure.

FIG. 3 is a schematic elevational diagram of the system of FIG. 2.

FIG. 4 is a plot of temperature (Y-axis) versus time (X-axis) for a representative cementitious board made by a system for manufacturing a cementitious board constructed in accordance with principles of the present disclosure including an embodiment of a dryer constructed in accordance with principles of the present disclosure, illustrating the temperature of the cementitious board over time as it moves downstream from the cutter along the machine direction through the dryer.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

The present disclosure provides various embodiments of a dryer that can be used in the manufacture of products, including cementitious boards such as gypsum wallboard, for example. Embodiments of a dryer constructed in accordance with principles of the present disclosure can be used in a manufacturing process to effectively remove excess water from a cementitious board while using thermal energy recovered from air exhausted from a heating section of the dryer and introduced into an entry section of the dryer. Embodiments of a dryer constructed in accordance with principles of the present disclosure can remove excess water from a cementitious board while using thermal energy recovered from air exhausted from a heating section of the dryer that includes at least one active (fuel-consuming) heating element and introduced into an entry section of the dryer that does not include an active heating element.

In embodiments, diverting recovered waste heat to an entry section of the dryer can improve the efficiency of the dryer to thereby lower the amount of energy otherwise needed to dry the cementitious boards passing through the dryer. In embodiments, directing recovered low temperature waste heat to the entry section of the dryer can act to pre-heat incoming cementitious boards such as gypsum wallboard panels so that the core panel temperature continues to be maintained or rise as it moves through the entry section of the dryer and into the heating section. In embodiments, the air heated via recovered waste heat and introduced into the entry section temperature has a temperature in a range between 30 and 150 °C, and is preferably less than 100 °C.

In embodiments, the dryer can be configured to recover thermal energy from the exhausted waste air using any suitable technique. For example, the dryer can include a heat exchanger configured to interact with air exhausted from the heating section to heat fresh air and to direct the heated fresh air to the entry section of the drying chamber. In embodiments, air exhausted from the heating section of the dryer chamber can be directed to the entry section. In embodiments, any suitable mechanism for recovering waste heat can be used, such as via quench, heat pump, and/or direct injection.

In embodiments, the dryer includes a housing which defines a heating section, an entry section upstream of the heating section that defines an inlet, and an exit section downstream of the heating section that defines an outlet. In embodiments, the housing includes enclosures that define both the entry section and the exit section such that the dryer inlet and outlet are enclosed. In embodiments, enclosing the dryer inlet and outlet increases the residence time to which material is subjected in the drying process without increasing the overall length of the heating section of the dryer. In embodiments, the dryer inlet and outlet enclosures can help reduce heat loss to the surrounding environment.

The present disclosure provides various embodiments of a dryer that can be used in the manufacture of different types of cementitious boards as will be appreciated by one skilled in the art. Embodiments of a dryer constructed in accordance with principles of the present disclosure can include enclosed entry and exit sections that define an inlet and an outlet, respectively. In embodiments, thermal energy is recovered, via a suitable heat exchanger, for example, from waste heat exhausted from a heating section of the dryer and directed to at least one of the entry section and the exit section. In embodiments, a system for manufacturing a cementitious board constructed according to principles of the present disclosure can be used to make a cementitious board, such as, a gypsum wallboard, an acoustical gypsum fiberboard, or a portland cement board, for example.

In embodiments, following principles of the present disclosure, the cementitious slurry can be any conventional cementitious slurry, for example any cementitious slurry suitable to produce gypsum wallboard as will be appreciated by one skilled in the art; acoustical panels including, for example, acoustical panels described in U.S. Patent Application Publication No. 2004/0231916; or portland cement board, for example. As such, the cementitious slurry can further comprise any additive that is commonly used in the production of cementitious products. Such additives include structural additives, including mineral wool, continuous or chopped glass fibers (also referred to as fiberglass), perlite, clay, vermiculite, calcium carbonate, polyester, and paper fiber, and chemical additives, including foaming agents, fillers, accelerators, sugar, enhancing agents (such as phosphates, phosphonates, borates and the like), retarders, binders (such as starch and latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Patent Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

Non-limiting examples of cementitious materials include portland cement, sorrel cement, slag cement, fly ash cement, calcium alumina cement, water-soluble calcium sulfate anhydrite, calcium sulfate α-hemihydrate, calcium sulfate β-hemihydrate, natural, synthetic or chemically-modified calcium sulfate hemihydrate, calcium sulfate dihydrate (“gypsum,” “set gypsum,” or “hydrated gypsum”), and mixtures thereof. In one aspect, the cementitious material desirably comprises calcined gypsum (sometimes referred to as, “stucco”), such as in the form of calcium sulfate alpha hemihydrate, calcium sulfate beta hemihydrate, and/or calcium sulfate anhydrite. The calcined gypsum can be fibrous in some embodiments and nonfibrous in other embodiments. In embodiments, the calcined gypsum can include at least 50% beta calcium sulfate hemihydrate. In other embodiments, the calcined gypsum can include at least 86% beta calcium sulfate hemihydrate.

The weight ratio of water to calcined gypsum in a cementitious slurry suitable for use in embodiments following principles of the present disclosure can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the cementitious slurry can be prepared by combining water and calcined gypsum in a suitable water to stucco weight ratio for board production depending on products, such as in a range between 1:6 and 1:1, e.g., 2:3.

In embodiments of systems and methods according to principles of the present disclosure, the cementitious board manufactured can be in the form of gypsum wallboard. As used herein, the term wallboard is not limited to the use of the board on walls, but can also include boards used for ceilings, partitions, etc. The board includes a set gypsum core disposed between first and second cover sheets (commonly face and back sheets, respectively). The set gypsum core is formed from a cementitious slurry comprising stucco, water, and optional ingredients as desired, including, for example, foaming agent, accelerator (e.g., heat resistant accelerator), retarder, dispersant, migrating starch, polyphosphate, etc. A dense layer can be provided that generally has a significantly greater density and significantly lesser thickness than that of the remainder of the board core. The face side of the board normally is facing out and is visible when installed to the structure, while the back side faces inward, toward support structures such as studs.

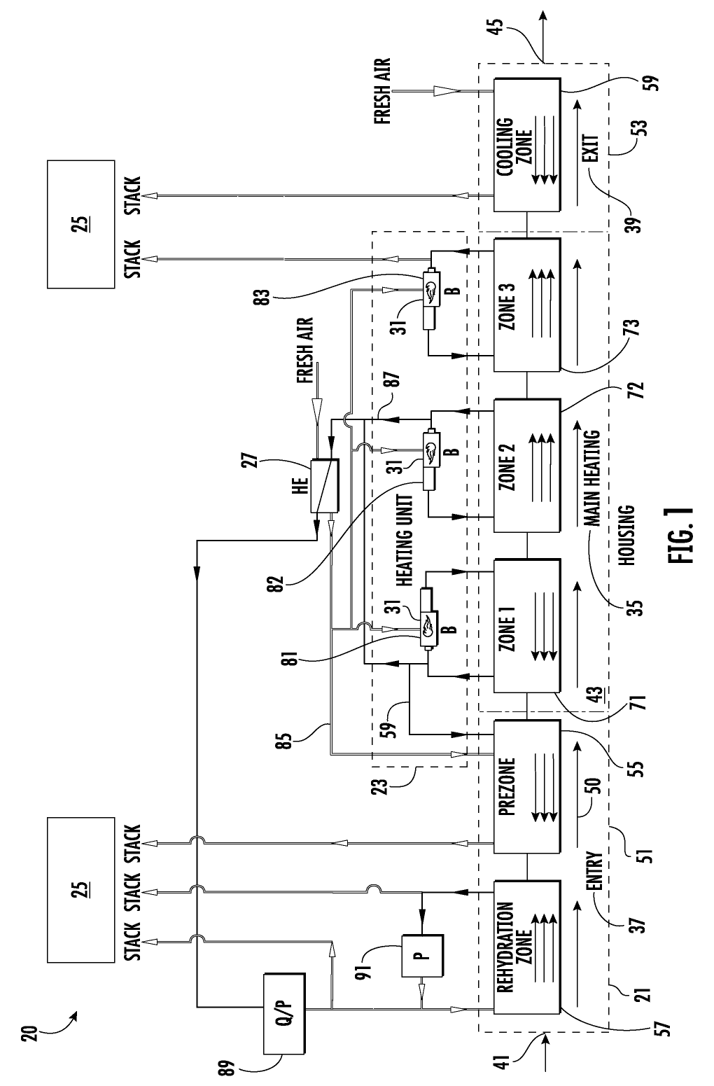

Turning now to the Figures, an embodiment of a dryer constructed according to principles of the present disclosure is shown schematically in FIG. 1. The dryer 20 includes a housing 21, a heating unit 23, an exhaust stack 25, and a heat exchanger 27. The housing 21 is configured to house the cementitious board in an environment configured to promote drying of the cementitious board (e.g., by removing excess water therefrom). The heating unit 23 is configured to heat the interior of the housing 21 via at least one fuel-consuming burner 31. The exhaust stack 25 is configured to vent the housing 21 to promote the efficient drying of cementitious board moving through the housing 21. The heat exchanger 27 is arranged with the exhaust stack 25 and configured to recover thermal energy from waste air that has been heated by the heating unit 23, directed through a main heating section 35 of the housing 21 and then vented therefrom via the exhaust stack 25. The heat exchanger 27 is configured to heat fresh air drawn through the heat exchanger 27 using the thermal energy from the vented waste air from the main heating section 35 and to direct the heated fresh air to an entry section 37 of the housing 21 upstream of the heating section 35.

The housing 21 defines a board inlet 41, a drying chamber 43, and a board outlet 45. The board inlet 41 and the board outlet 43 are in communication with the drying chamber 45 and are configured to permit the cementitious board to pass therethrough for conveying the cementitious board through the drying chamber 43. The board inlet 41 can be arranged with a conveyor of a manufacturing board line and is configured to receive the cementitious board from the conveyor and direct it into the drying chamber 43. The board outlet 45 is configured to permit the cementitious board to pass therethrough for discharging the cementitious board from the drying chamber 43 to continue moving along a machine direction 50 for subsequent processing (e.g., taping, stacking, bundling, etc.).

In the illustrated embodiment, the drying chamber 43 includes the entry section 37, the main heating section 35, and the exit section 39. The entry section 37 is associated with the board inlet 41 through which cementitious boards enter the drying chamber 43, and the exit section 39 is associated with the board outlet 45 out of which cementitious boards exit the drying chamber 43. The housing 21 includes an enclosed vestibule portion 51 defining the entry section 37 and an enclosed exit portion 53 defining the exit section 39. Each of the enclosed vestibule and exit portions 51, 53 has side walls extending along the machine direction 50 and a top cover as well as a transverse face wall defining the board inlet 41 and the board outlet 45, respectively, for substantially enclosing the entry and exit sections 37, 39.

In the illustrated embodiment, the main heating section 35 is interposed between the entry section 37 and the exit section 39 such that the main heating section 35 is disposed downstream of the entry section 37, and upstream of the exit section 39, along the machine direction 50. In embodiments, the main heating section 35 is divided into at least two heating zones 71, 72, 73 along the machine direction 50, wherein at least one heating zone 71 is subjected to a heating profile different from another heating profile in another heating zone 72.

The main heating section 35 of the illustrated embodiment includes three heating zones 71, 72, 73 which are independently arranged with the heating unit 23. The heating unit 23 is configured to independently heat the interior of the heating zones 71, 72, 73 such that at least one heating zone 71 can be subjected to a heating profile different from another heating profile in another of the heating zones 72, 73.

In embodiments, the main heating section 35 can comprise any suitable commercially-available dryer. For example in embodiments, the main heating section 35 includes a plurality of decks in vertical spaced relationship to each other to permit each deck to convey a cementitious board from the entry section through the main heating section 35. In such embodiments, the entry section 37 can include suitable conveyor equipment configured to selectively load the decks of the main heating section 35 with cementitious boards, as will be understood by one skilled in the art.

The heating unit 23 is configured to generate heated air and to move the heated air through the main heating section 35 of the housing 21 to promote convective heat transfer to the cementitious board. In embodiments, any suitable heating unit 23 can be used, such as any suitable commercially-available heating unit. In embodiments, the heating unit 23 includes at least one heating element 81, 82, 83 that consumes fuel, including electricity in the case of a resistive heating element.

In embodiments, the heating unit 23 includes at least one burner. Each burner can be operated using any suitable fuel, such as, e.g., natural gas, petroleum gas, oil, coal, etc. Fuel and air can be introduced to each burner of the heating unit to be burned, and the hot gases are then provided in the respective heating zone of the main chamber with which the burner is associated. In the illustrated embodiment, the heating unit 23 includes three heating elements 81, 82, 83 in the form of burners respectively operably arranged with the three heating zones 71, 72, 73 of the main heating section 35 of the drying chamber 43.

In embodiments, the burners 81, 82, 83 of the heating unit 23 can be arranged to direct heated air over the cementitious boards along a desired path relative to the movement of the cementitious boards along the machine direction 50. In the illustrated embodiment, the first burner 81 is configured to direct heated air over the cementitious boards in a direction counter to the machine direction 50, and the second and third burners 82, 83 are respectively configured to direct heated air in the second and third heating zones 72, 73 in the machine direction 50 over the cementitious boards. In other embodiments, the heating unit 23 can have a different configuration.

The exhaust stack 25 is in communication with the main heating section 35 for expelling air from the main heating section 35 out through the exhaust stack 25. In the illustrated embodiment, each of the heating zones 71, 72, 73 of the main heating section 35 is arranged with the exhaust stack 25 to vent the heating zones 71, 72, 73.

The heat exchanger 27 is operably arranged with the exhaust stack 25 and the entry section 37 of the drying chamber 43 and is configured to transfer thermal energy from the exhaust stack 25 to the entry section 37. In the illustrated embodiment, the heat exchanger 27 includes a fan arranged to draw fresh air through the heat exchanger 27 to produce heated fresh air and to deliver the heated fresh air to the entry section 37. The fan is operated to draw fresh air into the heat exchanger 27 to interact thermally with the waste air vented from the main heating section 35 via the exhaust stack 25 in order to transfer thermal energy from the waste air to the fresh air. A thermal line 85 is provided between the heat exchanger 27 and the entry section 37 to convey heated fresh air from the heat exchanger 27 to the entry section 37.

In embodiments, the heat exchanger 27 is configured such that the heated fresh air conveyed into the entry section 37 has a temperature in a range of 50 to 150 °C, a temperature in a range of 75 to 150 °C in other embodiments, a temperature in a range of 50 to 100 °C in other embodiments, and a temperature in a range of 75 to 100 °C in still other embodiments. In embodiments, the heat exchanger is configured such that the heated fresh air is less than 100 °C.

In embodiments, the heat exchanger 27 is configured such that the heated fresh air conveyed into the entry section 37 has a specific humidity of less than 30 grams of water vapor per kilogram of air (g/kg), and a specific humidity of less than 20 grams of water vapor per kilogram of air (g/kg) in other embodiments. In embodiments, the heat exchanger 27 is configured such that the heated fresh air delivered into the entry section 37 is conveyed at an airflow in a range between 10,000 and 20,000 m³/h.

The illustrated entry section 37 includes a prezone 55 and a rehydration zone 57 upstream of the prezone 55 along the machine direction 50. The prezone 55 is operably arranged with the heat exchanger 27 such that the fresh air drawn through the heat exchanger 27 and heated using the thermal energy from the vented waste air from the main heating section 35 is directed into the prezone 55 of the entry section 37. In embodiments, the entry section 37 can have a different configuration. For example, in embodiments, the entry section 37 can include a prezone and omit the rehydration zone.

The exit section 39 is disposed downstream of the main heating section 35 along the machine direction. The illustrated exit section 39 comprises a cooling zone. The cooling zone 39 is configured to help cool the cementitious board passing therethrough by directing fresh air over the cementitious board in a direction counter to the machine direction 50. The fresh air is vented out from the cooling zone 39 via the stack 25. In other embodiments, the exhaust air from the cooling zone 39 can be directed to the entry section 37, such as, e.g., the prezone 55, via a heat pump.

In the illustrated embodiment, a direct vent line 59 is provided between the first heating zone 71 of the main heating section 35 and the prezone 55 of the entry section 37 to direct waste heated air from the main heating section 35 into the entry section 37. In embodiments, the heating unit 23 and/or the first heating zone 71 is configured such that the waste heated air conveyed from the first heating zone 71 into the prezone 55 of the entry section via the direct vent line 59 has a temperature in a range of 100 to 175 °C, a temperature in a range of 100 to 160 °C in other embodiments, a temperature of about 130 °C in still other embodiments.

In embodiments, the heating unit 23 and/or the first heating zone 71 is configured such that the waste heated air conveyed from the first heating zone 71 into the prezone 55 of the entry section via the direct vent line 59 has a specific humidity in a range of 200 to 350 grams of water vapor per kilogram of air (g/kg), a specific humidity in a range of 200 to 300 grams of water vapor per kilogram of air (g/kg) in other embodiments, and a specific humidity of about 225 grams of water vapor per kilogram of air (g/kg) in still other embodiments. In embodiments, the heating unit 23 and/or the first heating zone 71 is configured such that the waste heated air conveyed from the first heating zone 71 into the prezone 55 of the entry section via the direct vent line 59 is conveyed at an airflow in a range between 10,000 and 20,000 m³/h.

In embodiments, the heat exchanger 27 is configured such that the heated fresh air conveyed into the prezone 55 via the thermal line 85 has a temperature in a range of 50 to 150 °C, a temperature in a range of 75 to 150 °C in other embodiments, and a temperature of about 90 °C in still other embodiments. In embodiments, the heat exchanger 27 is configured such that the heated fresh air conveyed into the prezone 55 via the thermal line 85 has a specific humidity in a range of 5 to 30 grams of water vapor per kilogram of air (g/kg), of less than 30 grams of water vapor per kilogram of air (g/kg) in other embodiments, a specific humidity of less than 20 grams of water vapor per kilogram of air (g/kg) in other embodiments, and of about 10 grams of water vapor per kilogram of air (g/kg) in still other embodiments. In embodiments, the heat exchanger 27 is configured such that the heated fresh air delivered into the prezone 55 via the thermal line 85 is conveyed at an airflow in a range between 10,000 and 20,000 m³/h.

In the illustrated embodiment, the stack 25 includes a vent line 87 that fluidly connects the second heating zone 72 of the main heating section 35 and the heat exchanger 27 such that waste heated air vented from the second heating zone 72 is fed through the heat exchanger 27 so that fresh air entering the heat exchanger 27 can thermally interact with the waste heated air vented from the second heating zone 72 to transfer thermal energy to the fresh air.

The vent line 87 is also in fluid communication with a quench and/ or heat pump 89 disposed downstream of the heat exchanger relative to the flow of waste heated air vented from the second heating zone 72. A heat pump 91 is provided to help circulate the waste heated air vented from the second heating zone 72 after it has passed through the quencher 89 through the rehydration zone 57 of the entry section 37.

In embodiments, the quench and/or heat pump 89 is configured such that the treated air conveyed into the rehydration zone 57 of the entry section 37 has a temperature in a range of 30 to 100 °C, a temperature in a range of 30 to 75 °C in other embodiments, and a temperature of about 50 °C in still other embodiments. In embodiments, the quench and/or heat pump 89 is configured such that the treated air conveyed into the rehydration zone 57 of the entry section 37 has a specific humidity in a range of 5 to 40 grams of water vapor per kilogram of air (g/kg), a range of 20 to 40 grams of water vapor per kilogram of air (g/kg) in other embodiments, and of about 30 grams of water vapor per kilogram of air (g/kg) in still other embodiments. In embodiments, the quench and/or heat pump 89 is configured such that the treated air conveyed into the rehydration zone 57 of the entry section 37 is conveyed at an airflow in a range between 50,000 and 100,000 m³/h.

In embodiments, the heat exchanger 27 can have different configurations. For example, in embodiments, the heat exchanger 27 is operably arranged with the exhaust stack 25 in a different manner such as by being independently arranged with the first and second heating zones 71, 72 of the main heating section.

The dryer 20 is suitable for use in embodiments of a system for manufacturing cementitious board following principles of the present disclosure. In embodiments, the dryer 20 can be configured to return thermal energy from waste heat exhausted from a heating section of the dryer to an entry section of the dryer upstream of the heating section of the dryer.

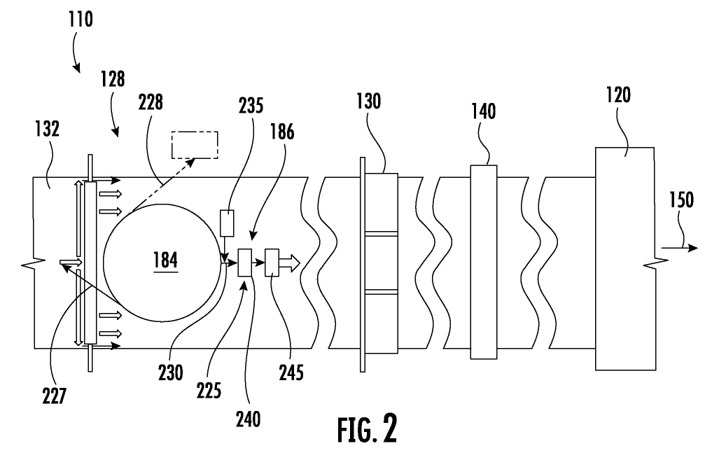

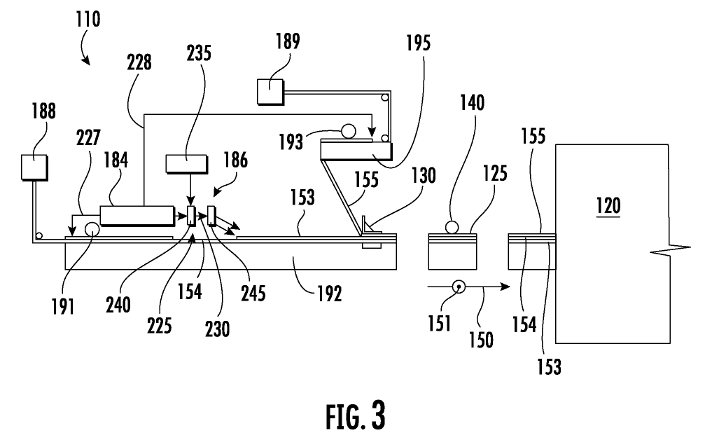

Referring to FIGS. 2 and 3, an embodiment of a system 110 for manufacturing a cementitious board 125 constructed according to principles of the present disclosure is shown. The illustrated system 110 includes a wet end system 128, a forming station 130, a conveyor 132, a cutting station 40, and a dryer 120 constructed according to principles of the present disclosure. The conveyor is configured to convey the cementitious board along a machine direction 150.

The wet end system 128 and the forming station 130 are configured to mix and assemble constituent materials together such that a continuous cementitious board 125 having a predetermined nominal thickness is fed from the forming station 130 along the conveyor 132 in the machine direction 150 toward the cutting station 140.

Referring to FIG. 3, the cementitious board 125 has a cementitious core 153 interposed between a pair of cover sheets 154, 155. The cementitious core 153 is formed from an aqueous cementitious slurry. The cementitious board 125 has a pair of edges extending along the machine direction 150. The edges are disposed in lateral spaced relationship to each other along a cross-machine direction 151 which is perpendicular to the machine direction 150.

The wet end system 128 can include any suitable equipment adapted to mix and/or assemble the constituent materials forming the cementitious board 125. In embodiments, the wet end system 128 is configured as a gypsum wallboard wet end system.

Referring to FIGS. 2 and 3, the wet end system 128 includes a slurry mixer 184 in fluid communication with a slurry dispensing system 186. The slurry mixer 184 is adapted to agitate water and a cementitious material (such as, calcined gypsum, for example) to form aqueous cementitious slurry. Both the water and the cementitious material can be supplied to the mixer 184 via one or more inlets as is known in the art. In embodiments, any other suitable slurry additive can be supplied to the mixer 184 as is known in the art of manufacturing cementitious products. In embodiments, the 184 mixer 184 includes a housing and an agitator disposed within the housing. The agitator is configured to agitate water and a cementitious material to form an aqueous cementitious slurry. Any suitable mixer (e.g., a pin mixer as is known in the art and commercially available from a variety of sources) can be used.

In use, water and a cementitious material, such as calcined gypsum, for example, can be agitated in the mixer 184 to form aqueous cementitious slurry. In some embodiments, water and calcined gypsum can be continuously added to the mixer 184 in a water-to-calcined gypsum ratio from about 0.5 to about 1.3, and in other embodiments of about 0.9 or less.

The slurry dispensing system 186 is in fluid communication with the slurry mixer 184 and is configured to dispense a main flow of cementitious slurry from the slurry mixer 184 upon a forming table extending between the slurry dispensing system 186 and the forming station 130. In embodiments, the slurry dispensing system 186 can include a suitable discharge conduit, as is known in the art. The discharge conduit can be made from any suitable material and can have different shapes. In some embodiments, the discharge conduit can comprise a flexible conduit. Cementitious slurry can be discharged from the slurry dispensing system 186 in an outlet flow direction substantially along the machine direction 150. In the illustrated embodiment, the slurry dispensing system 186 includes a main discharge conduit 225 and a pair of auxiliary discharge conduits 227, 228 in fluid communication with the slurry mixer 184 via, respectively, a main outlet and a pair of secondary outlets defined in the housing.

The main discharge conduit 225 is configured to deliver a main flow of cementitious slurry from the mixer 184 downstream to a further manufacturing station (e.g., upon a moving web of cover sheet material in embodiments used to produce gypsum wallboard). The main discharge conduit 225 is in fluid communication with the mixer 184. In embodiments, the main discharge conduit 225 can comprise any suitable discharge conduit component as will be appreciated by one skilled in the art. The illustrated main discharge conduit 225 includes a delivery conduit 230, a foam injection system 235, a flow-modifying element 240, and a slurry distributor 245.

The delivery conduit 230 defines a slurry passage. The conduit 230 is connected to the mixer 184 such that the slurry passage is in fluid communication with the main outlet. In embodiments, the delivery conduit 230 can be made from any suitable material and can have different shapes. In some embodiments, the delivery conduit 230 can comprise a flexible conduit.

In embodiments, the flow-modifying element 240 is a part of the main discharge conduit 225 and is adapted to modify a flow of cementitious slurry from the mixer 220 through the main discharge conduit 225. The flow-modifying element 240 is disposed downstream of the foam injection system 235 relative to a flow direction of the flow of cementitious slurry from the mixer 220 through the main discharge conduit 225. In embodiments, one or more flow-modifying elements 240 can be associated with the main discharge conduit 225 and adapted to control a main flow of slurry discharged from the slurry mixer 220. The flow-modifying element(s) 240 can be used to control an operating characteristic of the main flow of aqueous cementitious slurry. In the illustrated embodiment of FIGS. 2 and 3, the flow-modifying element(s) 240 is associated with the main discharge conduit 225. Examples of suitable flow-modifying elements include volume restrictors, pressure reducers, constrictor valves, canisters etc., including those described in U.S. Patent Nos. 6,494,609; 6,874,930; 7,007,914; and 7,296,919, for example.

In embodiments, the slurry distributor 245 can be any suitable terminal portion of a conventional discharge conduit, such as a length of conduit in the form of a flexible hose or a component commonly referred to as a “boot.” In embodiments, the boot can be in the form of a multi-leg discharge boot.

In other embodiments, the slurry distributor 245 can be similar to those shown and described in U.S. Patent Application Nos. 2012/0168527; 2012/0170403; 2013/0098268; 2013/0099027; 2013/0099418; 2013/0100759; 2013/0216717; 2013/0233880; and 2013/0308411. In some of such embodiments, the main discharge conduit 225 can include suitable components for splitting a main flow of cementitious slurry into two flows which are re-combined in the slurry distributor 245.

In embodiments, the foam injection system 235 can be arranged with at least one of the mixer 184 and the delivery conduit 230. The foam injection system 235 can include a foam source (e.g., such as a foam generation system configured as known in the art) and a foam supply conduit.

In embodiments, any suitable foam source can be used. Preferably, the aqueous foam is produced in a continuous manner in which a stream of a mix of foaming agent and water is directed to a foam generator, and a stream of the resultant aqueous foam leaves the generator and is directed to and mixed with the cementitious slurry. In embodiments, any suitable foaming agent can be used. Preferably, the aqueous foam is produced in a continuous manner in which a stream of the mix of foaming agent and water is directed to a foam generator, and a stream of the resultant aqueous foam leaves the generator and is directed to and mixed with the slurry. Some examples of suitable foaming agents are described in U.S. Patent Nos. 5,683,635 and 5,643,510, for example.

The aqueous foam supply conduit can be in fluid communication with at least one of the slurry mixer 184 and the slurry dispensing system 186. An aqueous foam from a source can be added to the constituent materials through the foam supply conduit at any suitable location downstream of the mixer 184 and/or in the mixer 184 itself to form a foamed cementitious slurry. In embodiments, the foam supply conduit is disposed downstream of the slurry mixer 184 and is associated with a main delivery trunk of the discharge conduit 186. In the illustrated embodiment, the foam supply conduit is disposed downstream of the slurry mixer and is associated with the delivery conduit 230. In some embodiments, the aqueous foam supply conduit has a manifold-type arrangement for supplying foam to a plurality of foam injection ports defined within an injection ring or block disposed at a terminal end of the foam supply conduit and associated with the delivery conduit 230, as described in U.S. Patent No. 6,874,930, for example. In embodiments, a flow-modifying element is disposed downstream of the foam injection body and the aqueous foam supply conduit relative to a flow direction of the flow of cementitious slurry from the mixer 184 through the discharge conduit 186.

In other embodiments, one or more foam supply conduits can be provided in fluid communication with the mixer 184. In yet other embodiments, the aqueous foam supply conduit(s) can be in fluid communication with the slurry mixer 184 alone. As will be appreciated by those skilled in the art, the means for introducing aqueous foam into the mixer 184 and/or the slurry dispensing system 186, including its relative location in the system, can be varied and/or optimized to provide a uniform dispersion of aqueous foam in the cementitious slurry to produce board that is fit for its intended purpose.

Referring to FIG. 3, a first roll 188 of cover sheet material is configured to be selectively dispensed such that the first cover sheet 154 is dispensed from the first roll 188 upstream of the slurry dispensing system 186 upon the forming table extending between the slurry mixer 184 and the dispensing system 186 and the forming station 30. A second roll 189 of cover sheet material is configured to be selectively dispensed such that the second cover sheet 155 is dispensed from the second roll 189 upon the forming table at a position between the slurry dispensing system 186 and the forming station 130 over the first cover sheet 154 and the slurry 153 dispensed from the slurry dispensing system 186. Gypsum board products are typically formed “face down” such that the first cover sheet 154 dispensed from the first roll 188 traveling over the forming table serves as the “face” cover sheet 154 of the finished cementitious board 125.

As one of ordinary skill in the art will appreciate, one or both of the webs 154, 155 of cover sheet material can be pre-treated with a very thin relatively denser layer of gypsum slurry (relative to the gypsum slurry comprising the core), often referred to as a skim coat in the art, and/or hard edges, if desired. To that end, the first auxiliary discharge conduit 227 is adapted to deposit a stream of dense aqueous calcined gypsum slurry (i.e., a “face skim coat/hard edge stream”) that is relatively denser than the main flow of aqueous calcined gypsum slurry discharged from the main discharge conduit 225.

The first auxiliary discharge conduit 227 can include an additive injection system suitable for introducing at least one additive into the face skim coat/hard edge stream. An additive(s) supply can be placed in fluid communication with the additive injection system of the first auxiliary discharge conduit 227 to inject at least one additive into the face skim coat/hard edge stream. In embodiments, the additive(s) supply comprises fiber.

Referring to FIG. 3, the exemplary embodiment of a wet end system 128 of a gypsum wallboard manufacturing line includes a hard edge/face skim coat roller 191 disposed upstream of the slurry distributor 245 of the main discharge conduit 225 and supported over a forming table 192 such that a first moving web 154 of cover sheet material is disposed therebetween, and a back skim coat roller 193 disposed over a support element 195 such that a second moving web 155 of cover sheet material is disposed therebetween. The skim coat rollers 191, 193, the forming table 192, and the support element 195 can all comprise conventional equipment suitable for their respective intended purposes as is known in the art.

The wet end system 128 can be equipped with other conventional equipment as is known in the art. For example, board manufacturing techniques described in, for example, U.S. Patent 7,364,676 and U.S. Patent Application Publication No. US2010/0247937 can be incorporated into the wet end system 128.

In embodiments, the hard edge/face skim coat roller 191 is disposed upstream of the slurry dispensing system 186 and supported over the forming table 192 such that the first cover sheet 154 being dispensed from the first roll 188 is disposed therebetween. The first auxiliary conduit 227 can deposit the face skim coat/hard edge stream upon the first cover sheet 154 being dispensed from the first roll 188 upstream of the skim coat roller 191 which is adapted to apply a skim coat layer to the moving first cover sheet 154 and to define hard edges at the periphery of the moving first cover sheet 154 by virtue of the width of the roller being less than the width of the moving first cover sheet 154 as is known in the art. Hard edges can be formed from the same dense slurry that forms the thin dense layer by directing portions of the dense slurry around the ends of the roller 191 used to apply the dense layer to the first cover sheet 154.

In embodiments, the back skim coat roller 193 is disposed over the support element 195 such that the second cover sheet 155 being dispensed from the second roll 189 is disposed therebetween. The mixer 184 can also include a second auxiliary conduit 228 adapted to deposit a stream of dense aqueous calcined gypsum slurry that is relatively denser than the main flow of aqueous calcined gypsum slurry delivered to the discharge conduit 186 (i.e., a “back skim coat stream”). The second auxiliary conduit 228 can deposit the back skim coat stream upon the moving second cover sheet 155 upstream (in the direction of movement of the second cover sheet 155) of the back skim coat roller 193 that is adapted to apply a skim coat layer to the second cover sheet 155 being dispensed from the second roll 189 as is known in the art.

In embodiments, the second auxiliary discharge conduit 228 can include an additive injection system suitable for introducing at least one additive into the back skim coat stream. An additive(s) supply can be placed in fluid communication with the additive injection system of the second auxiliary discharge conduit 228 to inject at least one additive into the back skim coat stream. In embodiments, the additive(s) supply comprises fiber.

In other embodiments, separate auxiliary conduits can be connected to the mixer 184 to deliver one or more separate edge streams to the moving cover sheet. Other suitable equipment (such as auxiliary mixers) can be provided in the auxiliary conduits to help make the slurry therein denser, such as by mechanically breaking up foam in the slurry and/or by chemically breaking down the foam through use of a suitable de-foaming agent.

The forming station 130 is configured to form the cementitious board 125 such that the cementitious board 125 is within a predetermined thickness range. The forming station 130 can comprise any equipment suitable for its intended purpose as is known in the art.

The conveyor 132 is configured to convey the cementitious board 125 along the machine direction 150 away from the forming station 130 through the dryer 120. The conveyor 132 can be configured such that the edges of the cementitious board 125 extend in substantially parallel relationship with the machine direction 150. In embodiments, the conveyor 132 is configured such that it has a length, measured along the machine direction 150, sufficient to allow the cementitious slurry constituting the cementitious core 153 to adequately set before reaching the cutting station 140 such that the cementitious board 125 can be cut cleanly. The temperature of the cementitious slurry rises during the setting process, which is an exothermic reaction that generates heat.

The cutting station 140 is disposed downstream of the forming station 130 along the machine direction 150. The cutting station 140 is arranged with respect to the conveyor 132 such that the conveyor 132 carries the cementitious board 125 past the cutting station 140. The cutting station 140 can include a knife configured to periodically cut the cementitious board 125 along the cross-machine direction 151 to define a series in board segments as the cementitious board 125 moves along the machine direction 150 past the cutting station 140. In embodiments, the knife can be a rotary knife as is generally known to those skilled in the art.

In embodiments, a dryer 120 constructed according to principles of the present disclosure can be associated with the conveyor 132 to receive cementitious board 125 therefrom in a continuous manner as is known in the art. A dryer 120 constructed in accordance with principles of the present disclosure can advantageously be configured as a retrofit in an existing wallboard manufacturing system. The dryer 120 can be used with components of a conventional wallboard manufacturing line.

In embodiments, the system 110 for manufacturing a cementitious board 125 can include other components and stations. For example, in embodiments, the system 110 can include a transfer system with a board inverter downstream of the cutting station 140 and upstream of the dryer 120 and a bundler and taping station downstream of the dryer 120.

In use, the gypsum board 125 can be prepared in any suitable manner. For example, in embodiments, the first cover sheet 154 is dispensed from the first roll 184 and moves along the machine direction 150. Water and calcined gypsum can be mixed in the mixer 184 to form an aqueous calcined gypsum slurry. In some embodiments, the water and calcined gypsum can be continuously added to the mixer in a water-to-calcined gypsum ratio from 0.5 to 1.3, and in other embodiments of 0.75 or less.

The foam injection system 235 can be used to inject aqueous foam into the calcined gypsum slurry produced by the mixer 184. A main flow of aqueous calcined gypsum slurry is discharged from the mixer 184 into the main discharge conduit 225. Aqueous foam is injected into the main flow of aqueous calcined gypsum slurry via the foam injection system 235 to form a flow of foamed calcined gypsum slurry. The main flow of foamed calcined gypsum slurry can be acted upon by one or more flow-modifying elements 240 and discharged from the slurry distributor 245 of the main discharge conduit 225 upon the first moving web 154.

The cementitious slurry is discharged from the discharge conduit 186 upon the moving first cover sheet 154. The face skim coat/hard edge stream can be deposited from the mixer 184 at a point upstream of where the cementitious slurry is discharged from the discharge conduit 186 upon the moving first cover sheet 154 relative to the direction of movement of the first cover sheet 154 in the machine direction 150. A back skim coat stream (a layer of denser slurry relative to the main flow of cementitious slurry being discharged from the discharge conduit 186) can be applied to the second cover sheet 155 being dispensed from the second roll 189. The back skim coat stream can be deposited from the mixer 184 at a point upstream of the back skim coat roller 193 relative to the direction of movement of the moving second cover sheet 155.

In embodiments, aqueous foam or other agents can be added to the slurry comprising the face skim coat and/or back skim coat to reduce its density, but at a density that is greater than the foamed slurry dispensed from the discharge conduit 186. In embodiments, fiber, starch, aqueous foam, or other additives can be added to the slurry comprising the face skim coat and/or back skim coat via additive injection systems respectively associated with the first and second auxiliary discharge conduits 227, 228.

The moving second cover sheet 155 can be placed upon the slurry deposited upon the advancing first cover sheet 154 to form a sandwiched wallboard preform that is fed to the forming station 130 to shape the preform to a desired thickness.

In embodiments, the main flow of cementitious slurry has a first volumetric flow rate, the face skim coat/hard edge stream has a second volumetric flow rate, and the back skim coat stream has a third volumetric flow rate. In embodiments, the first volumetric flow rate is greater than the second volumetric flow rate, and the first volumetric flow rate is greater than the second volumetric flow rate. In embodiments, the second volumetric flow rate is greater than the third volumetric flow rate.

Board 125 can be made with different dimensions, depending on, e.g., product type and market. The board 125 can have any suitable width (e.g., 48 inches to 54 inches), length (e.g., 96 inches to 192 inches), and thickness (e.g., ¼ inch, ³/₈ inch, ½ inch, ⁵/₈ inch, ¾ inch, 1 inch, etc.). The board thickness can vary depending on the location the board is used and the type of application for the product (e.g., regular board at one-half inch or fire-resistant board at ⁵/₈ inch, i.e., 0.625 inch). Dimensions in different markets may vary slightly as is well understood in the art.

During the manufacturing process tests can be used to determine the thickness, density, and/or hardness of the core and dense layer(s). During the manufacturing process the densities of both the dense layer and core can be monitored by measuring the wet densities as follows. Slurry is poured into a cup with a known volume and the weight is recorded. Periodically, samples of both the dense and core layer slurries are poured into molds (cubes or discs) and both the wet and dry densities are estimated by measuring both the weights and dimensions before and after drying.

The core and dense slurry formulations can be made with any suitable water/stucco ratio, e.g., 0.4 to 1.5. For example, in some embodiments, the water/stucco ratio can be from 0.4 to 1.2, 0.4 to 1.1, 0.4 to 1, 0.4 to 0.9, 0.4 to 0.85, 0.45 to 0.85, 0.55 to 0.85, 0.55 to 0.8, 0.6 to 0.9, 0.6 to 0.85, 0.6 to 0.8, etc.

In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Patent Nos. 5,643,510; 6,342,284; and 6,632,550. It has been found that suitable void distribution and wall thickness can be effective to enhance strength, especially in lower density board (e.g., 35 pcf or less). See, e.g., U.S. Patent Application Publication Nos. US2007/0048490 and US2008/0090068. Evaporative water voids, generally having voids of about 5 µm or less in diameter, also contribute to the total void distribution along with the aforementioned air (foam) voids.

Additives such as accelerator (e.g., wet gypsum accelerator, heat resistant accelerator, and climate stabilized accelerator) and retarder are well known and can be included in the core slurry, if desired. See, e.g., U.S. Patent Nos. 3,573,947 and 6,409,825. For example, the core slurry can optionally include at least one dispersant to enhance fluidity in some embodiments. Like other ingredients, the dispersants may be included in a dry form with other dry ingredients and/or in a liquid form with other liquid ingredients in the core slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin.

Suitable additives for fire-rated and/or water resistant product can also optionally be included in the core slurry, including e.g., siloxanes (water resistance); fiber; heat sink additives such as aluminum trihydrite (ATH), magnesium hydroxide or the like; and/or high expansion particles (e.g., expandable to about 300% or more of original volume when heated for about one hour at 1560°F). See, e.g., U.S. Patent No. 8,323,785, filed as U.S. Patent Application No. 13/400,010 on February 17, 2012, for a description of these and other ingredients. In some embodiments, high expansion vermiculite is included, although other fire resistant materials can be included.

The cover sheets can be formed of any suitable material and basis weight. For example, some embodiments of the disclosure allow for good board strength even with the use of lower basis weight cover sheets such as, for example, less than 45 lbs./MSF (e.g., 33 lbs./MSF to 45 lbs./MSF) even for lower weight board (e.g., having a density of 35 pcf or below). However, if desired, in some embodiments, heavier basis weights can be used, e.g., to further enhance nail pull resistance or to enhance handling, e.g., to facilitate desirable “feel” characteristics for end-users. In some embodiments, to enhance strength (e.g., nail pull strength), especially for lower density board, one or both of the cover sheets can be formed from paper and have a basis weight of, for example, at least 45 lbs./MSF (e.g., from 45 lbs./MSF to 65 lbs./MSF, 45 lbs./MSF to 60 lbs./MSF, 45 lbs./MSF to 55 lbs./MSF, 50 lbs./MSF to 65 lbs./MSF, 50 lbs./MSF to 60 lbs./MSF, etc.). If desired, in some embodiments, one cover sheet (e.g., the “face” paper side when installed) can have aforementioned greater basis weight, e.g., to enhance nail pull resistance and handling, while the other cover sheet (e.g., the “back” sheet when the board is installed) can have somewhat lower weight basis if desired (e.g., weight basis of less than 45 lbs./MSF, e.g., from 33 lbs./MSF to 45 lbs./MSF (e.g., 33 lbs./MSF to 40 lbs./MSF).

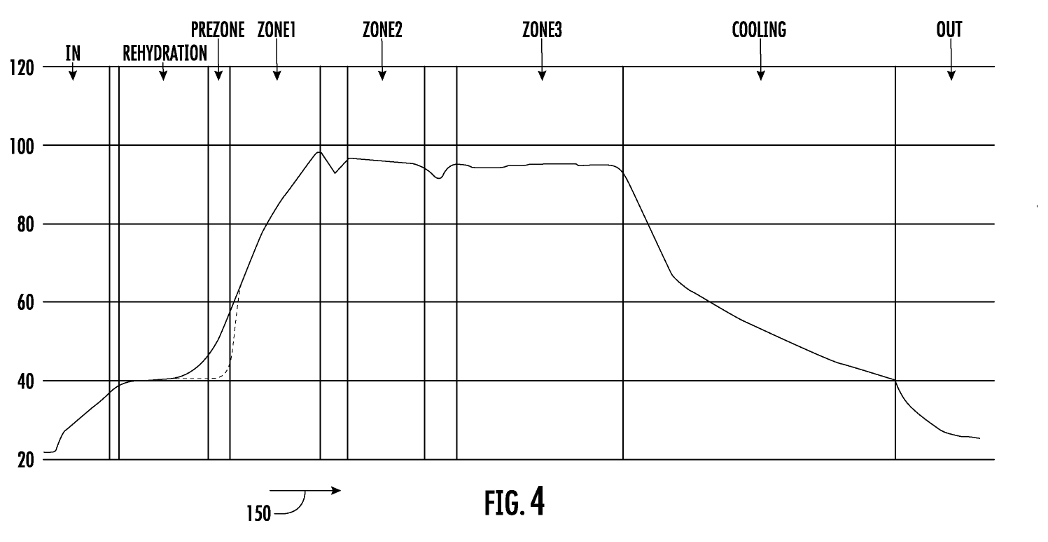

Referring to FIG. 4, in embodiments, directing recovered low temperature waste heat to the entry section of the dryer can act to pre-heat incoming cementitious boards such as gypsum wallboard panels so that the core panel temperature continues to be maintained or rise as it moves through the entry section of the dryer and into the heating section. FIG. 4 depicts an exemplary measurement of board temperature as the board moves through an embodiment of a dryer constructed according to principles of the present disclosure. In the illustrated embodiments, the dryer is configured such that thermal energy recovered from waste heat vented from the main heating section of the dryer is directed to the entry section of the dryer such that the temperature of the board rises as it moves through the prezone of the entry section, relative to what it would have been has the recovered thermal energy not been directed into the entry section (as illustrated by the dashed line).

In embodiments, a continuous, real-time temperature monitoring system can be provided along the machine direction 150 over the dryer 120, for example. In embodiments, any suitable slurry temperature monitoring system known to those skilled in the art can be used.

In embodiments, the continuous, real-time temperature monitoring system includes a series of infrared sensors disposed in spaced relationship to each other along the board line. Each infrared sensor can be configured to detect infrared radiant energy (heat) and convert the detected thermal energy values into an electronic signal, which is then processed to produce thermal data for the cementitious board as it travels along the machine direction 150.

A suitable processor can execute a thermal processing module of a board manufacturing program stored on a non-transitory computer-readable medium to generate a time/temperature graph representing the temperature measurement from the sensors of the temperature monitoring system. The thermal processing module can be configured to store time/temperature data representing the temperatures for a given product type and nominal thickness in a data storage device for use by a board measurement module of the board manufacturing program.

In embodiments, a board manufacturing program following principles of the present disclosure can be configured to implement an embodiment of a method for manufacturing cementitious board according to principles of the present disclosure. In embodiments, the board manufacturing program includes a graphical user interface that can be displayed by the display device. The graphical user interface can be used to facilitate the inputting of commands and data by a user to the board manufacturing program and to display outputs generated by the board manufacturing program.

The board manufacturing program can be stored upon any suitable computer-readable storage medium. For example, in embodiments, a board manufacturing program following principles of the present disclosure can be stored upon a hard drive, floppy disk, CD-ROM drive, tape drive, zip drive, flash drive, optical storage device, magnetic storage device, and the like.

In embodiments, an operator can set a predetermined tolerance range for the measured board temperature as it moves through the dryer, and the board measurement program can be configured to operate an alarm if the temperature falls outside of the tolerance range. In embodiments, the alarm can be any suitable alarm including an audible signal and/or a warning message displayed via the graphical user interface on the display device.

In embodiments of a method of manufacturing a cementitious board following principles of the present disclosure, a dryer constructed according to principles of the present disclosure is used to remove excess water from the cementitious board in an on-line manner during the continuous manufacture of the cementitious board. In embodiments, a method of manufacturing a cementitious board following principles of the present disclosure can be practiced using any embodiment of a dryer constructed according to principles discussed herein.

In embodiments following principles of the present disclosure, a method of making a cementitious board includes directing recovered low temperature waste heat to a dryer entry section to pre-heat incoming cementitious boards such as gypsum-based panels so that the core panel temperature continues to be maintained, or rise, as it enters the dryer. In embodiments, the method includes directing recovered waste heat from an outlet of a heat exchanger and/or a dryer exhaust to the entry section of a drying chamber. In embodiments, the method includes increasing the residence time cementitious boards are subjected to the drying process by enclosing an entry section, which does not include a fuel-consuming heating element of the heating unit, without increasing the overall length of the main heating section of the dryer.

In embodiments, using recovered waste heat improves the efficiency of the dryer to thereby lower the amount of energy needed to dry the gypsum boards which translates to lower greenhouse gas emission. In embodiments, enclosed vestibule and exit portions of the housing are provided upstream and downstream of the main heating section, respectively, to help prevent heat loss into surrounding environment.

In one embodiment of a method of making a cementitious board, the cementitious board is conveyed along a machine direction into a board inlet of a dryer. The dryer includes a housing defining the board inlet, a drying chamber, and a board outlet. The board inlet and the board outlet are in communication with the drying chamber. The drying chamber includes an entry section and a main heating section. The main heating section is disposed downstream of the entry section along the machine direction. Heated air is moved over the cementitious board in the main heating section. Air is exhausted from the main heating section via an exhaust stack. The exhausted air is at a temperature lower than the heated air. Thermal energy is directed from the exhausted air to the entry section. In embodiments of a method following principles of the present disclosure, at least a portion of the air exhausted from a first heating zone located along the machine direction is diverted to the entry section.

In embodiments, directing thermal energy from the exhausted air to the entry section includes using a heat exchanger operably arranged with the exhaust stack to transfer thermal energy from the exhaust stack to the entry section by heating fresh air taken into the heat exchanger and conveying it into the entry section. In embodiments, the heated fresh air conveyed into the entry section has a temperature in a range of 50 to 150 °C, a temperature in a range of 50 to 100 °C in other embodiments, a temperature in a range of 75 to 150 °C in still other embodiments, and a temperature in a range of 75 to 100 °C in yet other embodiments. In embodiments, the heated fresh air conveyed into the entry section has a humidity of less than 30 grams of water vapor per kilogram of air (g/kg). In embodiments, the heated fresh air conveyed into the entry section is conveyed at an airflow in a range between 10,000 and 20,000 m³/h.

In embodiments, the housing defines an exit section disposed downstream of the main heating section along the machine direction. In embodiments, the housing includes an enclosed exit portion defining the exit section.

In embodiments, the main heating section includes at least two heating zones arranged along the machine direction, each zone having associated therewith at least one burner of a heating unit. Moving heated air over the cementitious board in the main heating section can include subjecting at least one heating zone to a heating profile different from another heating profile in another heating zone.

All references cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. Neither gypsum nor water in a cementitious slurry is considered to be an “additive.” When amounts are compared between the core and dense layer slurries, it will be understood that it is in relation to a relative comparison, i.e., concentration. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing a cementitious board, the system comprising:
a conveyor, the conveyor configured to convey the cementitious board along a machine direction;
a dryer, the dryer including a housing, a heating unit, an exhaust stack, and a heat exchanger,
the housing defining a board inlet, a drying chamber, and a board outlet, the board inlet and the board outlet in communication with the drying chamber, the board inlet arranged with the conveyor and configured to receive the cementitious board therethrough, the drying chamber including an entry section and a main heating section disposed downstream of the entry section along the machine direction,
the heating unit configured to generate heated air and to move the heated air through the main heating section of the housing to promote convective heat transfer to the cementitious board,
the exhaust stack in communication with the main heating section for expelling air from the main heating section out through the exhaust stack, and
the heat exchanger operably arranged with the exhaust stack and the entry section of the drying chamber and configured to transfer thermal energy from the exhaust stack to the entry section.

2. The system for manufacturing according to claim 1, wherein the housing includes an enclosed vestibule portion defining the entry section.

3. The system for manufacturing according to claim 1, wherein the main chamber includes a plurality of decks in vertical spaced relationship to each other to permit each deck to convey a cementitious board from the entry section through the main chamber.

4. The system for manufacturing according to claim 1, wherein the main chamber is divided into at least two heating zones along the machine direction, wherein at least one heating zone is subjected to a heating profile different from another heating profile in another heating zone.

5. The system for manufacturing according to claim 1, wherein the drying chamber of the housing includes an exit section disposed downstream of the main heating section along the machine direction, the housing including an enclosed exit portion defining the exit section.

6. The system for manufacturing according to claim 5, wherein the exit section is arranged with a source of fresh air configured to pass through the exit section in a direction counter to the machine direction.

7. The system for manufacturing according to claim 1, wherein the heat exchanger includes a fan arranged to draw fresh air through the heat exchanger to produce heated fresh air and to deliver the heated fresh air to the entry section.

8. The system for manufacturing according to claim 7, wherein the heat exchanger is configured such that the heated fresh air is less than 100 °C.

9. The system for manufacturing according to claim 8, wherein the heat exchanger is configured such that the heated fresh air has a specific humidity of less than 30 grams of water vapor per kilogram of air (g/kg).

10. The system for manufacturing according to claim 8, wherein the heat exchanger is configured such that the heated fresh air is delivered into the entry section at an airflow in a range between 10,000 and 20,000 m³/h.

11. A method of manufacturing a cementitious board, the method comprising:
conveying the cementitious board along a machine direction into a board inlet of a dryer, the dryer including a housing defining the board inlet, a drying chamber, and a board outlet, the board inlet and the board outlet in communication with the drying chamber, the drying chamber including an entry section and a main heating section disposed downstream of the entry section along the machine direction;
moving heated air over the cementitious board in the main heating section;
exhausting air from the main heating section, the exhausted air being at a temperature lower than the heated air;
directing thermal energy from the exhausted air to the entry section.

12. The method of manufacturing according to claim 11, wherein directing thermal energy from the exhausted air to the entry section includes using a heat exchanger operably arranged with the exhaust stack to transfer thermal energy from the exhaust stack to the entry section by heating fresh air taken into the heat exchanger and conveying it into the entry section.

13. The method of manufacturing according to claim 12, wherein the heated fresh air conveyed into the entry section has a temperature in a range of 50 to 150 °C.

14. The method of manufacturing according to claim 12, wherein the heated fresh air conveyed into the entry section has a temperature in a range of 50 to 100 °C.

15. The method of manufacturing according to claim 12, wherein the heated fresh air conveyed into the entry section has a humidity of less than 30 grams of water vapor per kilogram of air (g/kg).

16. The method of manufacturing according to claim 12, wherein the heated fresh air conveyed into the entry section is conveyed at an airflow in a range between 10,000 and 20,000 m³/h.

17. The method of manufacturing according to claim 12, wherein the housing defines an exit section disposed downstream of the main heating section along the machine direction, the housing including an enclosed exit portion defining the exit section.

18. The method of manufacturing according to claim 17, wherein the main heating section includes at least two heating zones arranged along the machine direction, each zone having associated therewith at least one burner of a heating unit, wherein moving heated air over the cementitious board in the main heating section includes subjecting at least one heating zone to a heating profile different from another heating profile in another heating zone.

19. The method of manufacturing according to claim 12, wherein the main heating section includes at least two heating zones arranged along the machine direction, each zone having associated therewith at least one burner of a heating unit, wherein moving heated air over the cementitious board in the main heating section includes subjecting at least one heating zone to a heating profile different from another heating profile in another heating zone.

20. The method of manufacturing according to claim 19, further comprising:
diverting at least a portion of the air exhausted from a first heating zone located along the machine direction to the entry section.
